(19) United States
(12) Patent Application Publication
(10) Pub. No.: US 2012/0205420 A1
(43) Pub. Date: Aug. 16, 2012

(54) COMBUSTION-TYPE DRIVE APPARATUS

(75) Inventors: Kenichi MIYATA, Anjo-shi (JP); Isao MIYASHITA, Anjo-shi (JP)

(73) Assignee: MAKITA CORPORATION, Anjo-shi (JP)

(21) Appl. No.: 13/366,723

(22) Filed: Feb. 6, 2012

(30) Foreign Application Priority Data
Feb. 15, 2011 (JP) 2011-029574

(51) Int. Cl. B25C 1/14

(52) U.S. Cl. 227/10

(57) ABSTRACT

Embodiments of the present invention may include a combustion-type drive apparatus comprising a drive mechanism and an illumination device. The drive mechanism is configured to generate a drive force through combustion of a gas. The drive force is utilized to drive-in a member. The illumination device comprises a lighting portion configured to illuminate a place where the member is being driven in.

This application claims priority to Japanese patent application serial number 2011-029574, the contents of which are incorporated herein by reference.

### BACKGROUND OF THE INVENTION

1. Field of the Invention

The present invention relates to a combustion type drive apparatus configured to drive in a member by utilizing a drive force generated through combustion of a gas. More specifically, embodiments of the present invention relate to a combustion type drive apparatus with an illumination device for lighting up a location for a drive operation.

2. Description of the Related Art

There has conventionally been known a drive apparatus configured to drive in a member such as a nail, rivet, or tack. Japanese Patent Application Laid-Open No. 2009-28835 and Japanese Patent Application Laid-Open No. 2009-28836 discuss a combustion type drive apparatus configured to drive in a member by utilizing a force generated through combustion of a gas.

When the conventional combustion type drive apparatus is being used, the location of a drive operation (hereinafter a “drive-in place”) can be rather dark and hard to see, making it rather difficult to accurately drive-in a member at the correct position. In view of this, an illumination device for illuminating the drive-in place for a drive operation is provided. Accordingly, there is a need for a drive apparatus which allows the drive-in place to be illuminated easily.

### SUMMARY OF THE INVENTION

One aspect of the present invention includes a drive apparatus and an illumination device. The drive apparatus is configured to generate a drive force through combustion of a gas. The drive force is utilized to drive in a member. The illumination device comprises a lighting portion configured to illuminate the drive-in place.

The combustion type drive apparatus itself is provided with an illumination device for illuminating the drive-in place. It is possible to illuminate the drive-in place solely by the combustion type drive apparatus without having to separately use an illumination device. This allows for a user to more easily view the drive-in place during a drive operation.

### BRIEF DESCRIPTION OF THE DRAWINGS

FIG. 1 is a perspective view of the left and front sides of a drive apparatus;

FIG. 2 is a perspective view of the left and rear sides of the drive apparatus of FIG. 1;

FIG. 3 is a perspective view of the right and rear sides of the drive apparatus of FIG. 1;

FIG. 4 is a perspective view of an upper side of the drive apparatus of FIG. 1;

FIG. 5 is a side view of the combustion type drive apparatus of FIG. 1;

FIG. 6 is a side view of the drive apparatus of FIG. 1 with a cross-sectional view of a part thereof for showing an inner mechanism;

FIG. 7 is an enlarged side view of a contact arm when a cap is removed;

FIG. 8 is an enlarged front view of the contact arm when the cap is removed;

FIG. 9 is a perspective view of an alternative drive apparatus;

FIG. 10 is a perspective view of an alternative drive apparatus; and

FIG. 11 is a perspective view of an alternative drive apparatus.

### DETAILED DESCRIPTION OF THE INVENTION

Each of the additional features and teachings disclosed above and below may be utilized separately or in conjunction with other features and teachings to provide improved drive apparatuses. Representative examples of the present invention, which utilize many of these additional features and teachings both separately and in conjunction with one another, will now be described in detail with reference to the attached drawings. This detailed description is merely intended to teach a person of ordinary skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful configurations of the present teachings.

A forward direction as seen in the drawings corresponds to the direction in which a driven member is driven in. A rear direction corresponds to an opposite direction of the forward direction. Right and left directions in the drawings are those as seen from a user of the apparatus facing the front direction. Upper and lower directions in the drawings are those as shown in the diagrams. An operation handle (handle structure) 13 allowing the user to manually grip the apparatus is provided on the lower side of a main body 11.

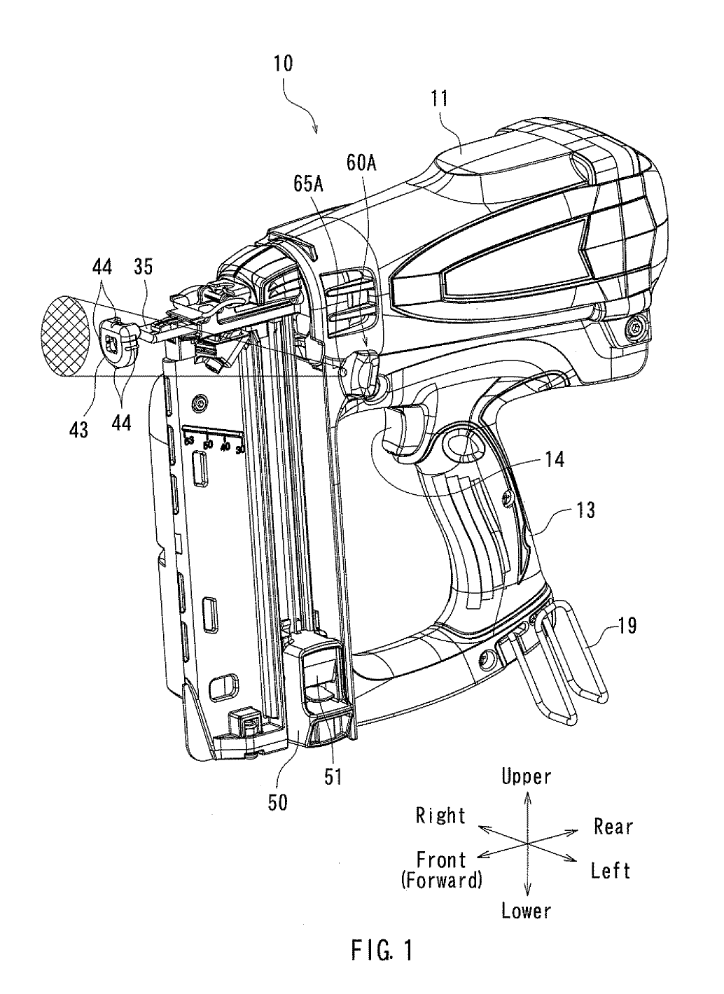

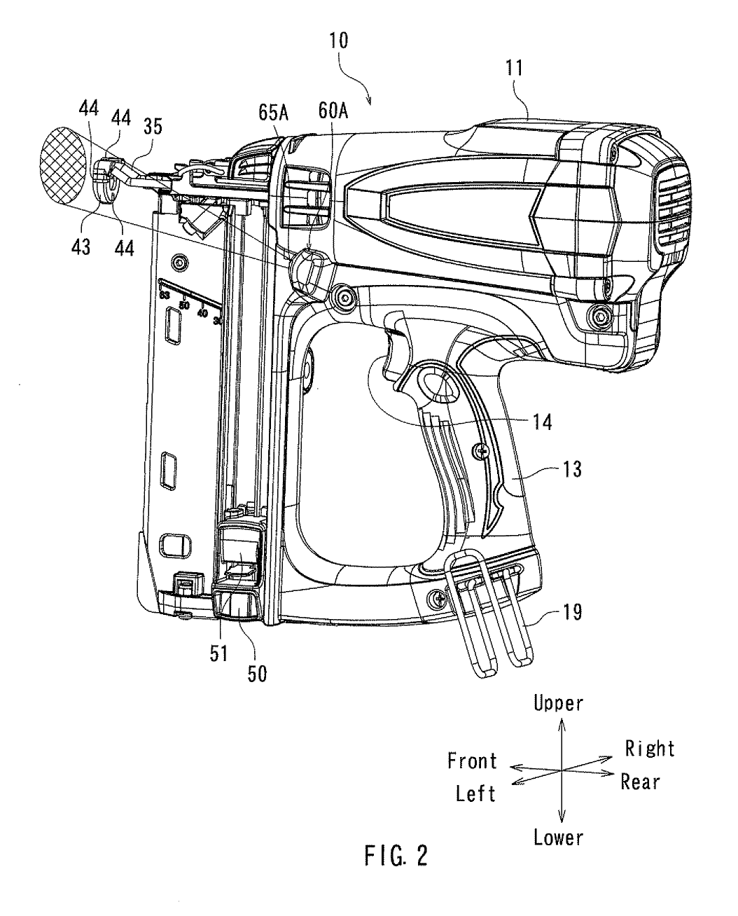

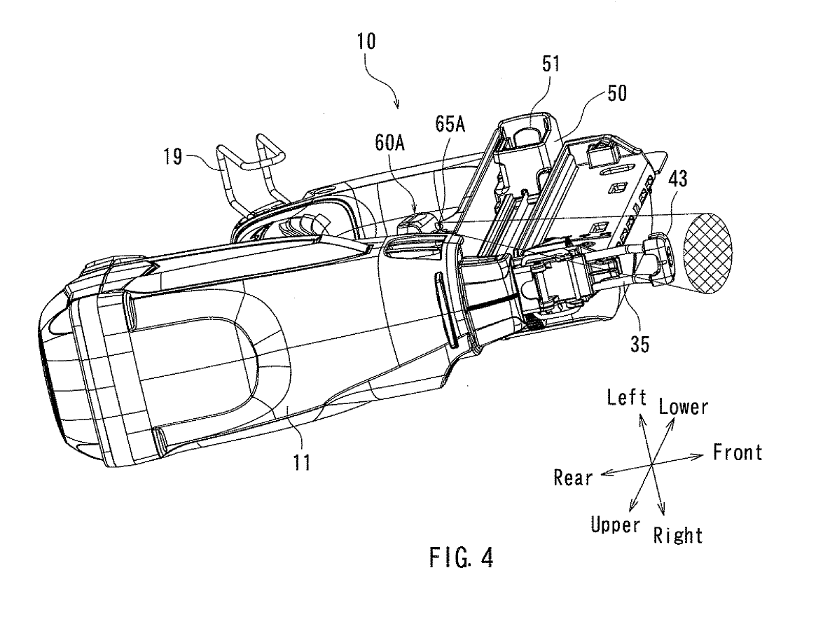

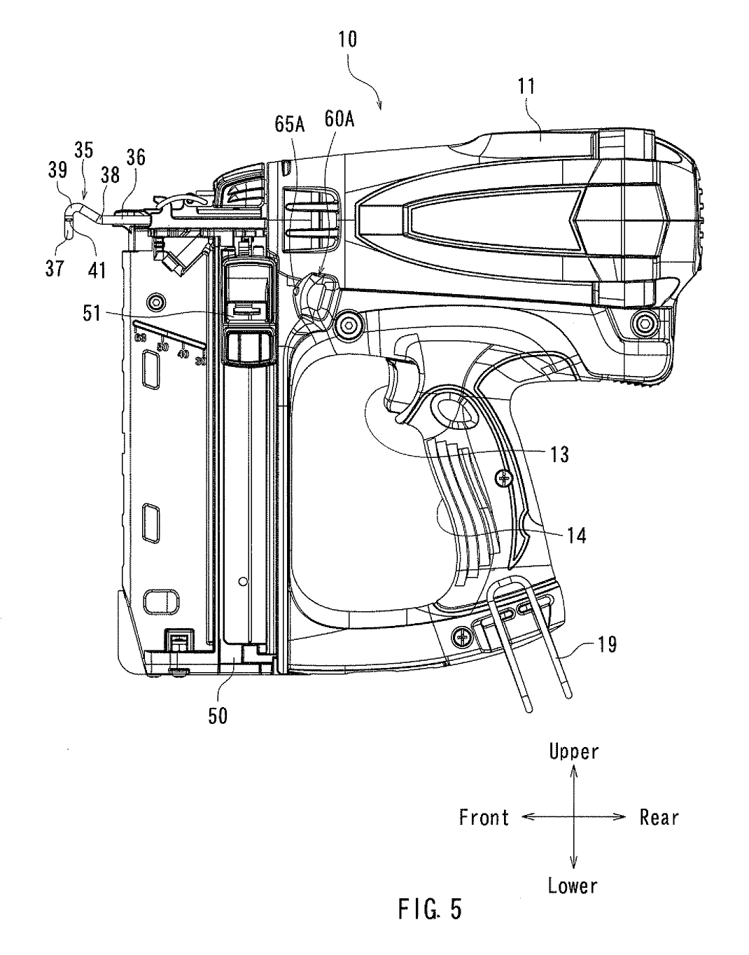

FIGS. 1 to 5 show a drive apparatus 10, which drives in a member by utilizing a drive force generated through combustion of a gas. The drive apparatus 10 is equipped with the main body 11 and a magazine 50 accommodating driven member(s).

The operation handle 13 is provided on the rear and lower side of the main body 11. The magazine 50 is arranged on the front and lower side of the main body 11. The drive apparatus 10 is formed in a configuration bridging the lower end of the operation handle 13 and the lower end of the magazine 50. The term “member” generally refers to a member such as a nail, rivet, tack or other member capable of being driven into another object. The drive apparatus 10 is configured to drive members.

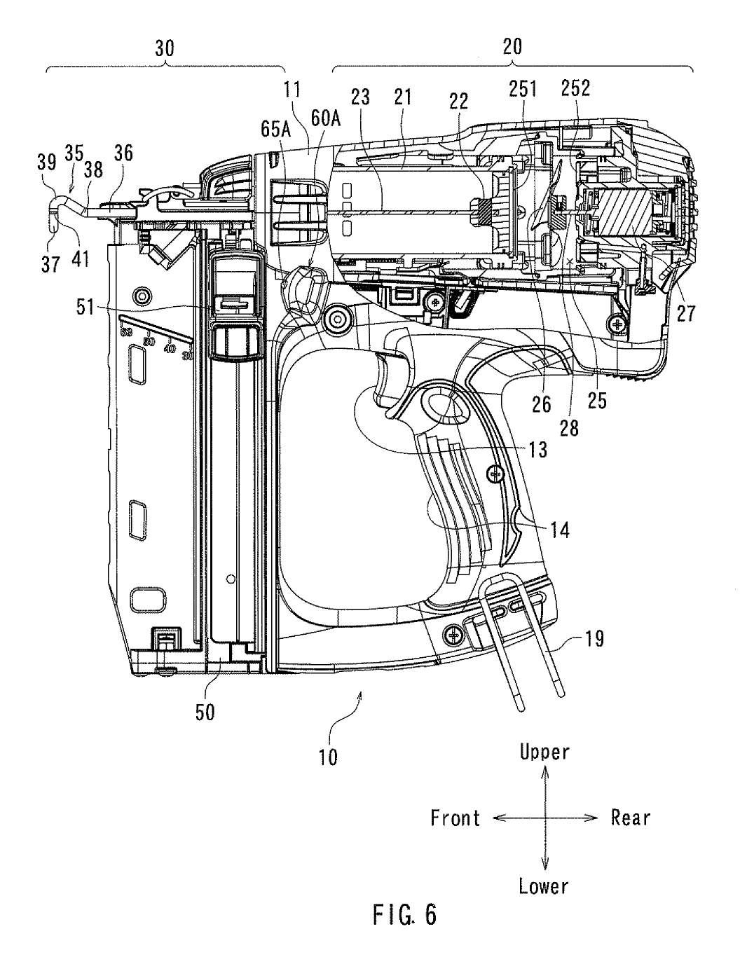

As shown in FIG. 6, the main body 11 is equipped with a drive mechanism 20 capable of generating a drive force through combustion of a gas, a guide mechanism 30 guiding a member in the forward direction by utilizing the drive force and an operation handle 13. Although not shown in FIGS. 1 to 6, attached to the main body 11 is a gas cylinder from which the gas for generating the drive force is supplied. The gas cylinder is a so-called cassette-type cylinder and is attached between the drive mechanism 20 and the operation handle 13. It allows for easy replacement.

The drive mechanism 20 may burn combustible gas supplied from the gas cylinder to generate the drive force. As shown in FIG. 6, the drive mechanism 20 is equipped with a cylinder 21 and a piston 22 configured to oscillate within the cylinder 21. On the front side of the piston 22, there is provided a driver 23 for driving a member. The driver 23 is formed so as to be elongated forwards from the center of the piston 22; the forward end portion of the driver 23 enters and is guided by the guide mechanism 30. The forward end of the driver 23 abuts the rear end of the member supplied in the guide mechanism 30.

The drive mechanism 20 is provided with a combustion chamber 25 for oscillating the piston 22 within the cylinder 21. The combustion chamber 25 is situated on the rear side of the cylinder 21. The combustion chamber 25 is a chamber defined by a piston proximal end wall 251 of the piston 22 and a head inner wall 252. Combustible gas is supplied into the combustion chamber 25 from the gas cylinder. When the combustible gas supplied from the gas cylinder is to be burned, the combustion chamber 25 is hermetically sealed; upon the combustion of the gas, the combustion chamber 25 is opened to discharge the exhaust gas. By burning the combustible gas in the combustion chamber 25, an operational force for oscillating the piston 22 is created.

The combustible gas supplied to the combustion chamber 25 is mixed with air to generate an air-gas mixture of a fixed ratio. A fan 26 may be provided in the combustion chamber 25. The fan 26 agitates the gas and the air, thereby enhancing the combustion efficiency at the time of combustion. The fan 26 is attached to an output shaft 28 of an electric motor 27 installed on the rear side and is rotated using the electric motor 27 as the drive source. An example of a fan 26 rotated by the electric motor 27 in a combustion chamber 25 is discussed in Japanese Patent Application Laid-Open No. 2009-28836.

A drive cycle for driving in a member is formed by components (the cylinder 21, the piston 21, the combustion chamber 25, etc.) of the drive mechanism 20. The electric motor 27 for rotating the fan 26, which also constitutes the drive mechanism 20, constitutes the drive cycle. The electric power for driving the electric motor 27 is utilized to burn the combustible gas in the drive cycle. This electric power is supplied from an electric power source 55 attached to an attachment portion 53.

The guide mechanism 30 is arranged on the front side of the drive mechanism 20. The driver 23 and the guide mechanism 30 are used to drive in members supplied from the magazine 50. The guide mechanism 30 has a mechanism for supplying members from the magazine 50 and a mechanism for guiding the driver 23. A contact arm 35 is attached to the front end portion of the guide mechanism 30.

The contact arm 35, which is a component of the guide mechanism 30, effects switching between a driving-in impossible state and a driving-in possible state. An abutment front side portion 37 of the contact arm 35 is held in contact with the portion where the driving-in is to be performed. During operation, the main body 11 is pushed in the driving-in (forward) direction. As a result, the contact arm 35 makes a rearward movement with respect to the main body 11 and the main body 11 is switched to the driving-in possible state from the driving-in impossible state.

The upper portion of the magazine 50 supplies members to the guide mechanism 30. The magazine 50 preferably accommodates a large number of members that are preferably arranged in parallel to each other. The magazine 50 accommodates the members and supplies them one-by-one to the guide mechanism 30 via a slider mechanism 51.

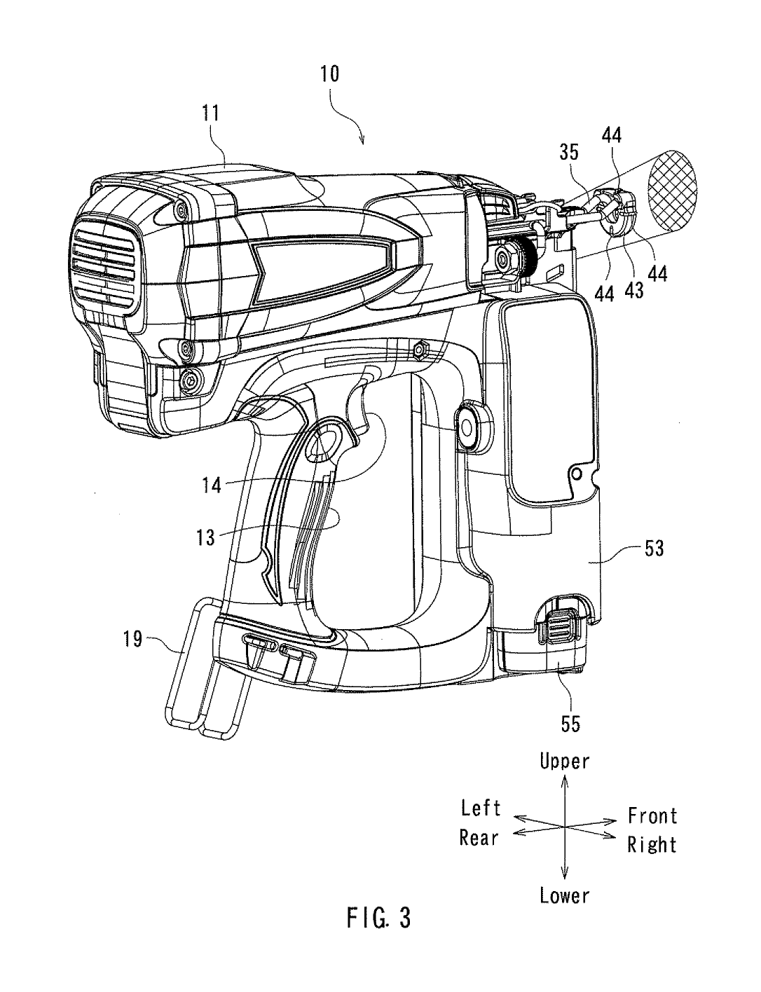

As shown in FIG. 3, the battery attachment portion 53 for attaching the power source 55 is provided on the right front side portion of the magazine 50. The attachment portion 53 has a structure allowing detachable attachment of the power source 55. The power of the power source 55 is supplied to the electric motor 27 for rotation of the fan 26 by the electric motor 27. When its storage amount has been reduced, the power source 55 may be detached from the power source attachment portion 53 for recharging or replacement. It is contemplated that power sources may be standard batteries, rechargeable batteries or other detachable power sources.

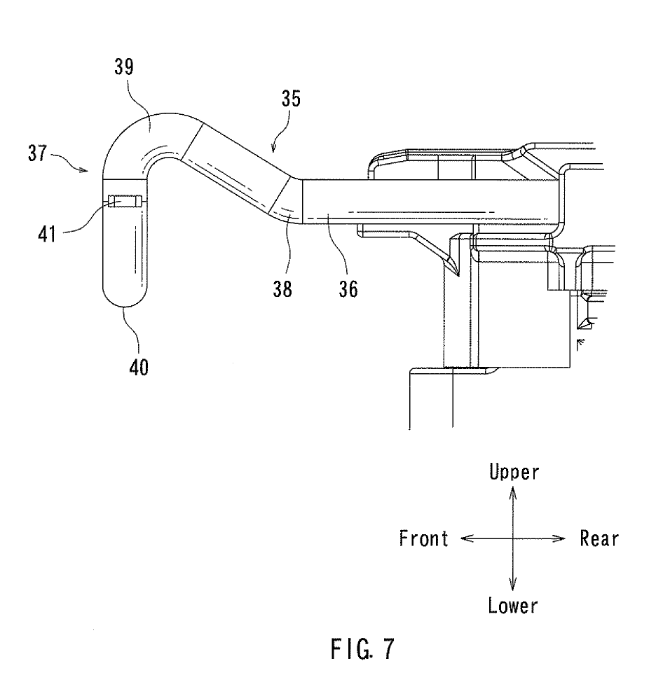

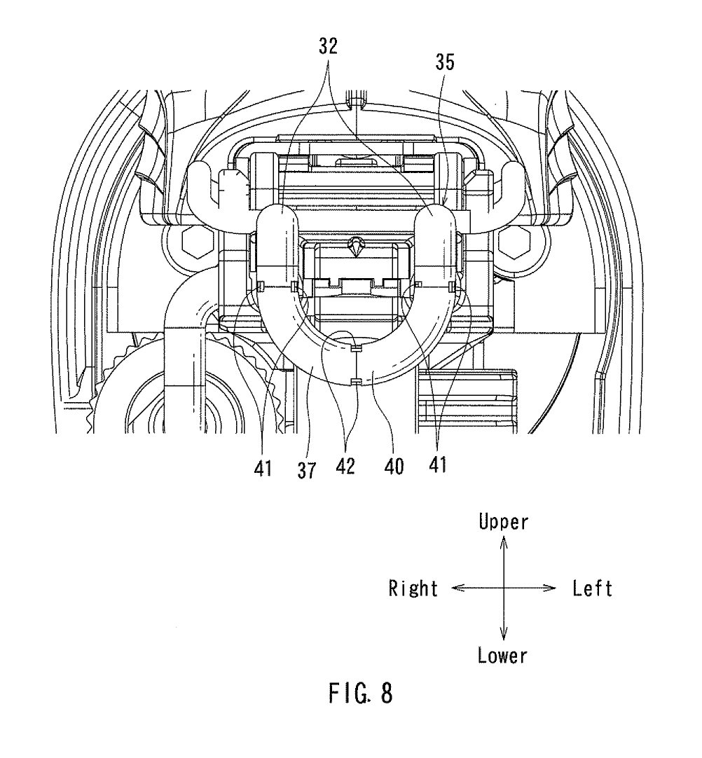

In FIGS. 1 to 5, a cap 43 is on the front surface of the contact arm 35. In FIGS. 7 and 8, the cap 43 has been removed from the front surface of the contact arm 35. The contact arm 35 is formed by bending a round bar. As shown in FIGS. 7 and 8, the contact arm 35 is provided with guide extension portions 36 which are inserted into the main body 11 and supported therein. The abutment front side portion 37 abuts the area where driving-in is to be performed and is located on the front side of the guide extension portion 36.

The guide extension portions 36 are substantially in the form of round bars, and extend in the forward direction from the right and left sides of the guide mechanism 30. The two guide extension portions 36 are connected together at the abutment front side portion 37. The positions of the two guide extension portions 36 are determined such that the member is shot between the two guide extension portions 36 from the guide mechanism 30.

The abutment front side portion 37 is supported by the guide extension portions 36 and is situated on the front side of the guide mechanism 30. The abutment front side portion 37 has a first bent portion 38 and a second bent portion 39. The first bent portion 38 is formed so as to be bent obliquely upwards with respect to the direction in which the guide extension portions 36 extend. The second bent portion 39 is situated on the upper side of the first bent portion 38 and extends vertically downwards. As shown in FIG. 8, the abutment front side portion 37 has a curved portion 40. The curved portion 40 consists of two round bars extending vertically downwards from the second bent portion 39 and laterally astride the lower side of the member shooting space, with the two round bars being connected together. The portion of the curved portion on the front side of the second bent portion 39 abuts the portion where the driving-in operation is to be performed.

On both the right and left sides of the curved portion 40, there are provided side marks 41 in the form of cutouts. The side marks 41 extend longitudinally in the direction of the guide extension portions 36 extend. Like the guide extension portions 36, the side marks 41 facilitate the visual checking of the member shooting direction when the curved portion 40 is seen in the lateral direction.

In FIG. 8, center marks 42 in the form of cutouts extending in the longitudinal direction are provided on both the upper and lower side surfaces of the lowermost area of the curved portion 40. The center marks 42 are situated between the two guide extension portions 36. When seen in the vertical direction, the center marks 42 facilitate the visual checking of the member shooting direction.

As shown in FIGS. 1 to 5, the cap 43 covers the portion which is on the front side of the second bent portion 39 and which abuts the portion where the driving-in operation is to be performed. The cap 43 is formed via resin molding and mitigates shock on the abutment front side portion 37 when the abutment front side portion 37 is brought into contact with the portion where a driving-in operation is to be performed. The cap 43 is provided with marked protrusions 44 corresponding to the side marks 41 and center marks 42 of the curved portion 40, with the marked protrusions 44 being exposed. When the cap 43 is attached to the curved portion 40 of the abutment front side portion 37, the marked protrusions 44 are visible from the right, left, upper, and lower sides. The curved portion 40 has an opening exposing an upper space and a connection portion connecting the lower sides thereof. The curved portion 40 allows for easy visual checking of the member shooting space from above.

The operation handle 13 has a configuration similar to that of a pistol grip. At a position corresponding to the trigger of a pistol, the operation handle 13 is provided with an operation trigger 14 for operating the drive apparatus 10. With the operation handle 13 held, the operation trigger 14 can be pulled with a fingertip. When the operation trigger 14 is pulled, a switch mechanism (not shown) contained in the main body 11 is operated. The switch mechanism transmits a signal to a control apparatus (not shown) contained in the main body 11 wherein the control apparatus causes the drive apparatus 10 to perform a drive operation. A hook member 19 is attached to a lower end portion of the operation handle 13. During a drive operation the hook member 19 is preferably engaged with a suspension structure, beam, stepladder or the like provided on a wall.

The drive apparatus 10 may be provided with an illumination device 60A for illuminating the place where the member drive operation is being performed. The illumination device 60A is preferably equipped with a light emitting diode (LED) 65A as the lighting portion. The illumination device 60A is supplied with power from the power source 55 to light the LED 65A. As shown in the diagrams, the LED 65A is configured to illuminate the driving-in place.

In the main body 11, the illumination device 60A is situated on the rear side of the magazine 50 and on the front side of the operation handle 13. As shown in the drawings, the illumination device 60A may be situated on the left-hand side surface of the main body 11. The illumination device 60A may be situated slightly on the front side of and slightly above the operation trigger 14.

The lighting of the illumination device 60A is turned on and off by a switch mechanism (not shown) configured to operate in conjunction with the pulling operation on the operation trigger 14. The switch mechanism is triggered during the operation of the drive apparatus 10, thereby illuminating the place where the member driving-in operation is being performed. The switch mechanism is activated by pulling on the operation trigger 14 to turn on the illumination device 60A. The switch mechanism switches the illumination device 60A to the lighting-off state after keeping it on for, for example, 30 seconds. Through the switch mechanism, the lighting-on time of the LED 65A is controlled.

Since it has the illumination device 60A for illuminating the driving-in place, the drive apparatus 10 can illuminate the driving-in place without having to use an external device.

The illumination device 60A is configured to light the LED 65A by electric power supplied from a power source 55. By incorporating the illumination device 60A into the drive apparatus 10 it is possible to illuminate the driving-in place without requiring an external lighting device.

The power source 55 supplies power to the electric motor 27 in order to rotate the fan 26. The fan is used in the combustion of a gas in the drive cycle. The power source 55 preferably has large power storage capacity, making it possible to supply power in a stable manner to the illumination device 60A.

The illumination device 60A is provided with the switch mechanism (not shown) for turning on and off the LED 65A. The switch mechanism may control the lighting of the illumination device 60A. Pulling on the operation trigger 14 activates the switch mechanism. Release of the operation trigger 14 serves to deactivate the switch mechanism thereby turning off the illumination device 60A.

The combustion type drive apparatus 10 preferably comprises: the drive apparatus main body 11 equipped with the drive mechanism 20 configured to generate a drive force through combustion of a gas and the magazine 50 arranged on the front, lower portion of the main body 11 and configured to accommodate one or more of the members. The main body 11 is provided with the operation handle 13 to be gripped by the user on the rear, lower portion of the main body 11. The LED 65A is preferably situated on the rear side of the magazine 50 and on the front side of the operation handle 13.

It is possible to illuminate the drive-in place operation when driving-in a member without being hindered by the magazine or a user's gripping of the operation handle 13. The LED 65A can illuminate the drive-in place without being obstructed by the operation handle 13. The illumination device 60A is preferably situated on the front side of and slightly above the operation trigger 14. As a result, the illumination device 60A can clearly illuminate the drive-in place without being obstructed by the hand of a user.

The illumination device 60A may be arranged on the left-hand side surface of the main body 11. The illumination device 60A can illuminate the drive-in place obliquely from left to right. As a result the user can easily view the drive-in place while activating the illumination device 60A of the apparatus 10. When the user can easily view the drive-in place while gripping the driving-in apparatus 10 with the right hand, the illuminating direction and the watching direction coincide with each other. That makes it easy for the user to watch the drive-in place.

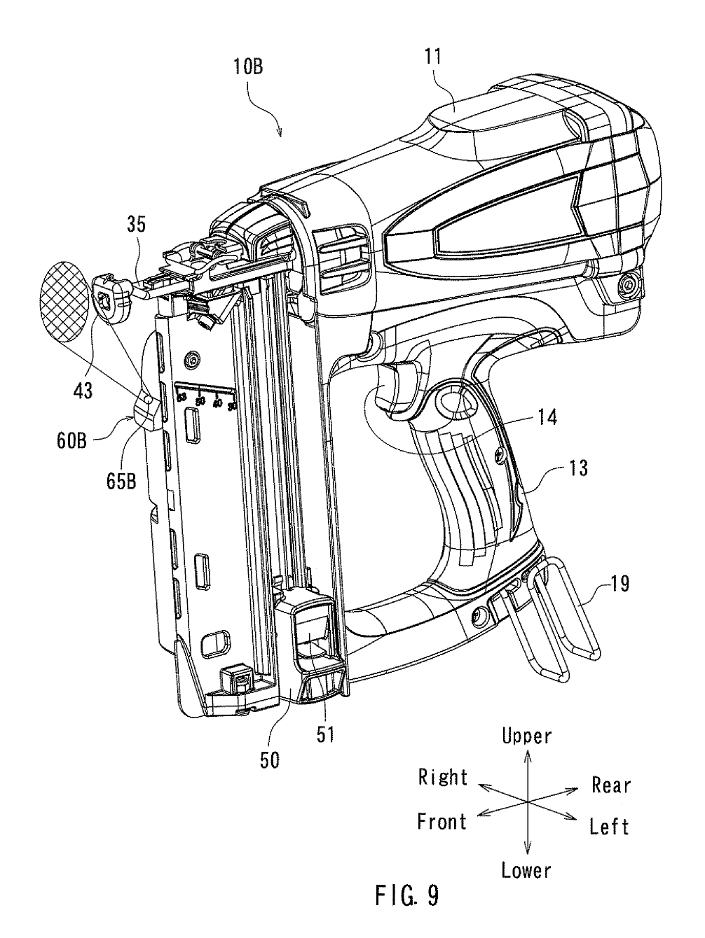

A second embodiment will be described with reference to FIG. 9. The location of the illumination device 6013 differs from that of the illumination device 60A in previous embodiments.

In the drive apparatus 1013, the illumination device 60B is situated on the front surface portion of the magazine 50. The illumination device 6013 may be equipped with an LED 65B for illuminating the drive-in place. In the drive apparatus 1013, the illumination device 60B may be generally located in front of most parts of the drive apparatus 10B. As a result, the illumination device 60B can illuminate the drive-in place from the foremost position where it is relatively free from obstacles. In FIG. 9, generally only the area of the contact aims 35 lie in front of the illumination device 60B.

In the drive apparatus 10B provided with the illumination device 6013, it is possible to obtain the same effect as that of the first embodiment and to perform illumination of the drive-in place. In this embodiment, the illumination device 6013 is located at a more forward position. In this way, the illumination device 60B can illuminate the drive-in place without being obstructed by a hand holding the drive apparatus 10B. Further, the illumination device 60B illuminates the drive-in place from below, so that it is possible to illuminate a portion which is otherwise likely to be shadowed.

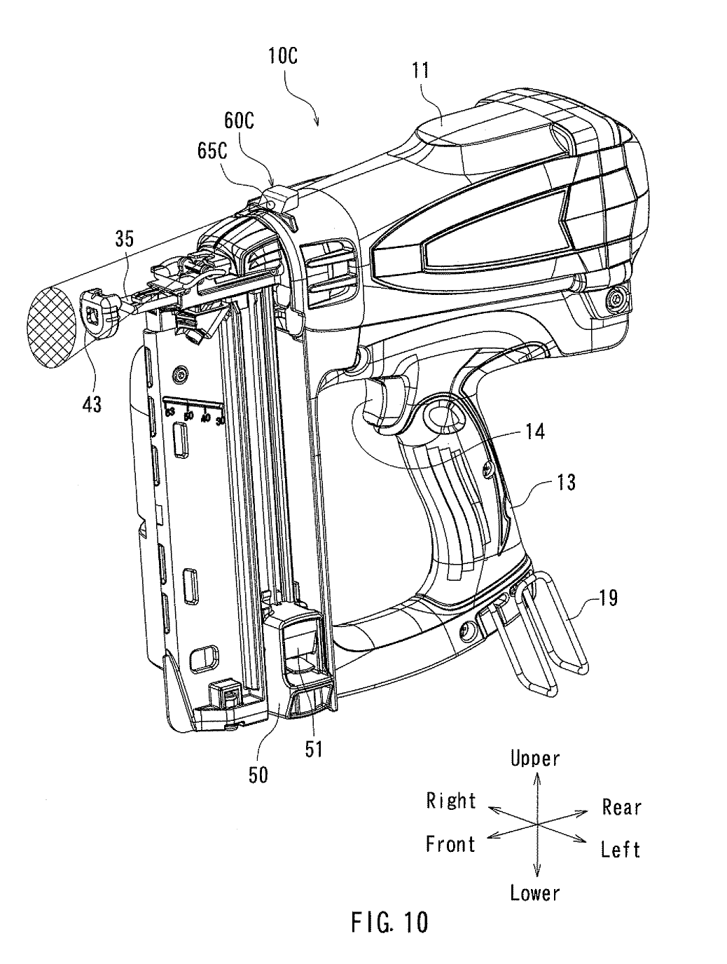

A third embodiment will be described with reference to FIG. 10. In a third embodiment of a drive apparatus 10C, the location of the illumination device 60C also differs from previous embodiments. The illumination device 60C of the drive apparatus 10C may be situated on the upper surface portion of the main body 11. Like the illumination device 60A in previous embodiments, the illumination device 60C may be equipped with an LED device 65C for illuminating the drive-in place. Thus, the illumination device 60C can illuminate the drive-in place from the uppermost portion of the drive apparatus 10, which is relatively free from obstacles at the time of illumination.

The drive apparatus 10C provided with the illumination device 60C is capable of illuminating the drive-in place from the uppermost portion of the drive apparatus 10. In this configuration, the illumination device 60C can illuminate the drive-in place without being obstructed by a user's hand holding the drive apparatus 10B. Further, the illumination device 60C illuminates the drive-in place from above, which can prove effective when the user needs to view a location below their eye-level.

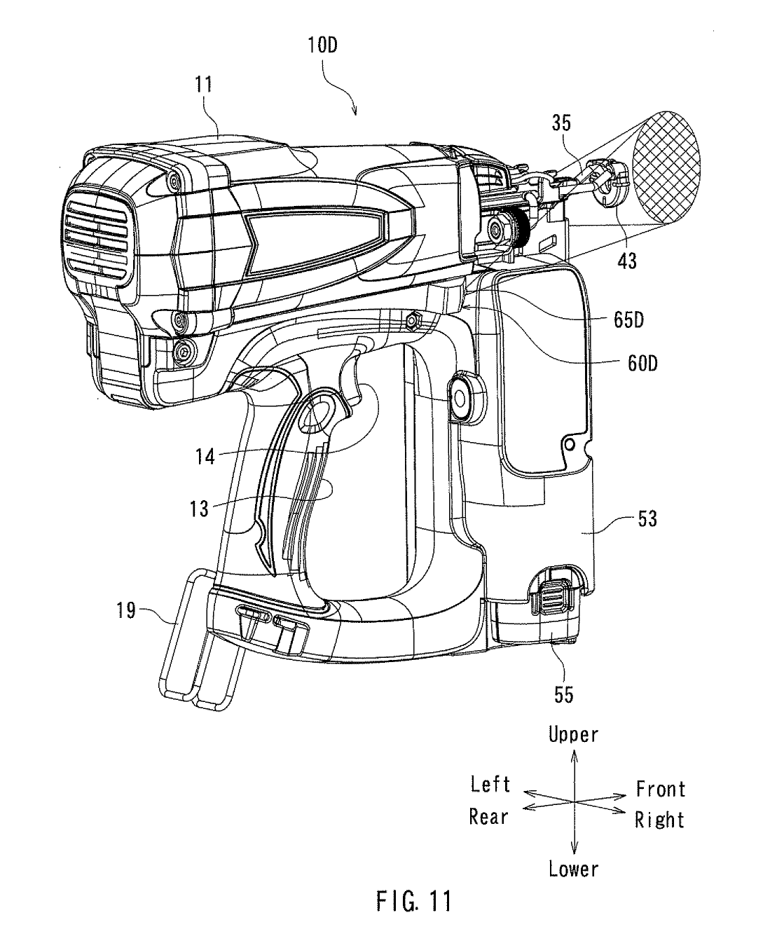

A fourth embodiment will be described with reference to FIG. 11. A drive apparatus 10D according to the fourth embodiment has an illumination device 60A (not shown in FIG. 11) arranged on the left-hand side surface of the main body 11, and an illumination device 60D arranged on the right-hand side of the main body 11. The illumination device 60D is situated laterally on the opposite side of the illumination device 60A.

Like the illumination device 60A according to the first embodiment, the device 60D is equipped with an LED 65D to illuminate the drive-in place. The drive apparatus 10D in the fourth embodiment has a plurality of (two) LEDs 65A and 65D at different positions. It is contemplated that other embodiments can have more than two illumination devices containing LEDs located at various areas on or attached to the main body 11.

The drive apparatus 10D, provided with the illumination devices 60A and 60D illuminate the drive-in place from both the right and left sides. As a result, even in a case where the user uses the drive apparatus 10 from varying altitudes, the drive-in place can be easily viewed. The LEDs 65A and 65D may illuminate the drive-in place from generally symmetrical positions on the right and left sides such that a member may be driven toward the center of the illuminated area.

Embodiments of the present invention may allow for driving of various members including, but not limited to nails, rivets and tacks.

The power source for lighting the illumination devices and LEDs may be a detachable battery or an alternative power source such as a corded plug.

The lighting of the illumination devices and LEDs may be turned on and off by a switch mechanism (not shown) configured to operate through activation of the operation trigger 14. It is contemplated that the switch mechanism may be activated by other alternative means such as an on-off switch. It is also contemplated that the illumination and/or LED portions may be independently turned or off while other operative devices of the drive apparatus 10 remain in operational or non-operational states.

The illumination and LED devices may also operate with increased intensity levels. For example, the switch mechanism may serve to activate the illumination device at a range of levels such as low, medium and bright lighting levels.

The drive apparatus may have two, three or more LED devices situated at appropriate positions on the drive apparatus.

This invention claims:

1. A drive apparatus comprising:
a drive mechanism configured to generate a drive force through combustion of a gas, a member, the drive force being utilized to drive-in the member; and
an illumination device comprising,
a lighting portion configured to illuminate a place where the member is being driven in.

2. The drive apparatus of claim 1 further comprising:
a power source for supplying electric power to be used to generate the drive force,
wherein the lighting portion of the illumination device is lighted by the electric power supplied from the same power source.

3. The drive apparatus of claim 2 further comprising:
a fan used in the combustion of the gas, and
a drive motor to rotate the fan,
wherein the power source supplies power to the drive motor to drive in the member.

4. The drive apparatus of claim 1 further comprising a switch mechanism configured to turn on and off the lighting portion.

5. The drive apparatus of claim 1, further comprising:
an apparatus main body on which the lighting portion is set;
a magazine to accommodate the member, the magazine positioned on a front side of a lower portion of the apparatus main body; and
a handle structure on a rear side of the lower portion of the apparatus main body;
wherein the lighting portion is situated on a rear side position of the magazine and on a front side position of the handle structure.

6. The drive apparatus of claim 1,
wherein there are provided a plurality of lighting portions, and
wherein the lighting portions are arranged at positions different from each other.
